(19) United States
(12) Patent Application Publication
(10) Pub. No.: US 2016/0169739 A1
(43) Pub. Date: Jun. 16, 2016

(54) ELECTROMAGNETIC WAVE DETECTING/GENERATING DEVICE

(71) Applicant: CANON KABUSHIKI KAISHA, Tokyo (JP)

(72) Inventors: Alexis Debray, Tokyo (JP); Ryota Sekiguchi, Hiratsuka-shi (JP)

(21) Appl. No.: 14/951,702

(22) Filed: Nov. 25, 2015

(30) Foreign Application Priority Data
Dec. 3, 2014 (JP) 2014-244601
Oct. 29, 2015 (JP) 2015-212602

(51) Int. Cl. G01J 1/44; H01Q 1/38; H01Q 9/04; H01Q 7/00

(52) U.S. Cl. CPC G01J 1/44; H01Q 7/00; H01Q 1/38; H01Q 9/04

(57) ABSTRACT

Provided is an electromagnetic wave detecting/generating device, including: an electronic element; and an antenna electrically connected to the electronic element, the antenna including at least one coil-shaped portion in which the electromagnetic wave detecting/generating device is configured to be driven at a frequency within ±15% of a first anti-resonant frequency of the antenna.

### BACKGROUND OF THE INVENTION

1. Field of the Invention

The present invention relates to an electromagnetic wave detecting/generating device and members used therein such as an antenna, and more particularly, to an electromagnetic wave detecting/generating device and an antenna that operate on an electromagnetic wave in an arbitrary frequency range out of a range from millimeter waves to terahertz waves (30 GHz to 30 THz) (this electromagnetic wave is hereinafter also referred to as terahertz wave (THz wave)). “Detecting/generating” herein means executing at least one of electromagnetic wave detection and electromagnetic wave generation (emission).

2. Description of the Related Art

Electromagnetic wave sensors as the one described above are arranged in an array pattern and used in combination with a suitable focal lens to construct a device for obtaining an image of a measurement subject in the terahertz range. Obtaining an image in the terahertz range is useful in various fields. For instance, terahertz-range images are useful in the security field such as a search for a concealed weapon because terahertz waves are transmitted through tissues such as clothes but not metal. Terahertz imaging is also of great use in the medical field. Specifically, the imaging of a living tissue in the terahertz range is helpful in detecting cancerous cells in a patient because cancerous tissues and healthy tissues have different refractive indexes with respect to terahertz waves.

In the field of this type of sensors, which emit electromagnetic waves in the terahertz range, it is a matter of importance to make a practical design for a rectifying element or the like that converts a terahertz-range signal into a signal having a frequency below the terahertz range, so that the lower-frequency signal can be handled easily by a regular electronic element. To that end, an electromagnetic wave that is transmitted through a medium and reaches the sensor needs to be coupled to the rectifying element. This coupling is accomplished usually by an antenna. The antenna and the rectifying element need to fulfill a conjugate matching condition in order to transmit power that is captured by the antenna to the rectifying element with high efficiency. The condition to be fulfilled is that the impedance of the antenna and the impedance of the rectifying element are in a complex conjugate relation.

The conjugate matching condition can be fulfilled with the use of a matching circuit or a transmission line at a low frequency that is in the gigahertz (GHz) range. In the case of a transmission line, the antenna, the transmission line, and the rectifying element all fulfill the conjugate matching condition, thereby preventing reflection at the interfaces between those elements, and even weak power can accordingly be transmitted with high efficiency. In the terahertz range, on the other hand, no existing matching circuit or transmission line meets the requirement, and the conjugate matching condition therefore needs to be fulfilled directly between the antenna and the rectifying element.

Rectifying elements that have sensitivity in the terahertz range are said to exhibit high impedance (for example, several thousand Ω to several million Ω). An antenna high in radiation impedance (for example, several thousand Ω to several million Ω) is accordingly necessary to transmit high power from the antenna to the rectifying element. In addition to this requirement, there is a requirement regarding the radiation pattern (directivity) of the antenna. The additional requirement is that an electromagnetic field emitted by the antenna needs to cancel out an electromagnetic field to be detected, which means that the direction of the emitted electromagnetic field and the direction of the detected electromagnetic field need to match. The radiation pattern of the antenna therefore needs to be controlled as well in the designing of the antenna.

Imaging requires a plurality of sensors (usually in thousands or more) arranged in an array pattern. An electronic switch or the like that is provided for each of the plurality of sensors is used to collect amplified signals from the sensors. A complementary metal-oxide semiconductor (CMOS) technology is one of technologies that are reliable in forming thousands of electronic switches on a single silicon wafer at present. On the other hand, an antenna fabricated on silicon, which is higher in permittivity than the air, has a radiation pattern that is directed toward the silicon rather than the air in the case where the antenna is surrounded by the air. Those factors need to be taken into consideration when designing an antenna for an array of terahertz-range sensors.

An antenna for a terahertz-range sensing device is disclosed in U.S. Patent Application Publication No. 2014/0117236. The antenna, which is for detection by a bolometer, is designed so as to have a small thermal capacity. The antenna has a skirt-like shape and the total length thereof is approximately one wavelength. In an example given in this patent literature, antennas having this shape and size are connected to a resistor and a thermal sensor. The radiation impedance of the antenna is approximately 100Ω, for example. An antenna disclosed in another example uses two loops and is low in resistance over a wide frequency range. It is not easy for those antennas to fulfill the conjugate matching condition when combined with a high-impedance rectifying element or the like. The disclosed antennas consequently cannot be used for the effective transmission of electromagnetic wave energy to a rectifying element having an impedance of several thousand Ω in some cases. In U.S. Patent Application Publication No. 2014/0117236, there is no disclosure of a method of controlling the radiation pattern of an antenna that is coupled to a silicon wafer in the process of manufacture.

As described above, the antennas according to the technology that is disclosed in U.S. Patent Application Publication No. 2014/0117236 to design an antenna for use in the terahertz range are low in radiation impedance. It is therefore not easy for the antennas to fulfill the conjugate matching condition when connected to a terahertz-range rectifying element or the like. Moreover, the method in order to design the radiation pattern of the antenna does not disclose in U.S. Patent Application Publication No. 2014/0117236.

### SUMMARY OF THE INVENTION

It is therefore an object of the present invention to provide an electromagnetic wave detecting/generating device including an antenna that has a relatively high radiation impedance and is accordingly connected suitably to an electronic element such as a rectifying element while fulfilling a conjugate matching condition.

According to one embodiment of the present invention, there is provided an electromagnetic wave detecting/generating device, including:

an electronic element; and

an antenna electrically connected to the electronic element, the antenna including at least one coil-shaped portion,

in which the electromagnetic wave detecting/generating device is configured to be driven at a frequency within ±15% of a first anti-resonant frequency of the antenna.

Further features of the present invention will become apparent from the following description of exemplary embodiments with reference to the attached drawings.

### BRIEF DESCRIPTION OF THE DRAWINGS

FIGS. 1A and 1B are a graph for showing the impedances of three types of antennas, which are excited in vacuum at a frequency around a first anti-resonant frequency, and a diagram for illustrating the radiation pattern of one of the antennas, respectively.

FIGS. 2A, 2B and 2C are a top view of a first example of a first embodiment of the present invention, a sectional view of the first example of the first embodiment taken along the line 2B-2B, and an enlarged side view of a Schottky barrier diode, respectively.

FIGS. 3A and 3B are a graph for showing the impedance of an antenna (hereinafter also referred to as “coil-shaped antenna”) on a silicon substrate which is excited at a frequency around the first anti-resonant frequency, and a diagram for illustrating the Poynting vector of a radiated energy of the antenna, respectively.

FIG. 4 is a diagram for illustrating an example of an electronic element (circuit) that includes a rectifying element connected to a coil-shaped antenna.

FIGS. 5A and 5B are a plan view of a fourth example of the first embodiment in which a coil-shaped antenna has two coil portions connected to one rectifying element, and a sectional view of the fourth example of the first embodiment taken along the line 5B-5B, respectively.

FIGS. 6A and 6B are a top view of a fifth example of the first embodiment in which a coil-shaped antenna stands upright on a silicon substrate, and a sectional view of the fifth example of the first embodiment taken along the line 6B-6B, respectively.

FIGS. 7A and 7B are a top view of a first example of a second embodiment of the present invention and a sectional view of the first example of the second embodiment taken along the line 7B-7B, respectively.

FIGS. 8A and 8B are a graph for showing the impedance of a coil-shaped antenna on a silicon substrate with a reflector which is excited at a frequency around the first anti-resonant frequency, and a diagram for illustrating the Poynting vector of a radiated energy of the antenna, respectively.

FIGS. 9A and 9B are a top view of a second example of the second embodiment and a sectional view of the second example of the second embodiment taken along the line 9B-9B, respectively.

FIGS. 10A and 10B are a graph for showing the impedance of a coil-shaped antenna on a silicon substrate with a reflector and an inversely tapered pillar portion which is excited at a frequency around the first anti-resonant frequency, and a diagram for illustrating the Poynting vector of a radiated energy of the antenna, respectively.

FIGS. 11A and 11B are a top view of a third example of the second embodiment and a sectional view of the third example of the second embodiment taken along the line 11B-11B, respectively.

### DESCRIPTION OF THE EMBODIMENTS

Preferred embodiments of the present invention will now be described in detail in accordance with the accompanying drawings.

In the present invention, a coil-shaped antenna is constructed as follows. The target operating frequency and the impedance of an electronic element to which the antenna is connected are determined first. Based on the determined frequency and impedance, the length, shape, and other specifics regarding the form of the coil-shaped antenna, which has at least one coil-shaped portion, are determined. On what substrate the antenna is formed is also considered at this point. The coil-shaped antenna can be designed by actually forming a few antennas on substrates, measuring each of the formed antennas with a measurement device in the wavelength of an electromagnetic wave in the antenna, in first anti-resonant frequency, in impedance, and the like, and using the results of the measurement. The size and the like of the antenna are designed in this manner based on a wavelength that corresponds to an operating frequency close to the first anti-resonant frequency.

When a modulation voltage is applied to a conducting wire, a substantially uniform current flows in the conducting wire at a low frequency. Raising the frequency of the applied modulation voltage gradually increases the degree of non-uniformity of the current flowing in the conducting wire. When the modulation voltage reaches a certain frequency, nodes where the flowing current is minimum begin to appear. When the number of nodes is two, one of the nodes appears at a feeding portion and the length of the conducting wire in this case is equivalent to one wavelength. The wavelength of an electromagnetic wave in the conducting wire can be determined in this manner. Now, a conducting wire half the wavelength of a certain frequency is considered. When a modulation voltage feeding portion is connected to this conducting wire, a voltage node appears at the midpoint of the conducting wire which is the center point of symmetry and is a voltage nodal point. The current peaks at the midpoint in response to the appearance of the voltage node. Because the length of the conducting wire is half the wavelength, the half length of the conducting wire is a quarter of the wavelength. This makes the voltage maximum and the current minimum at the feeding portion. The impedance viewed from the feeding portion is extremely high according to the Ohm's law. The present invention utilizes those facts to realize an antenna that has a high impedance.

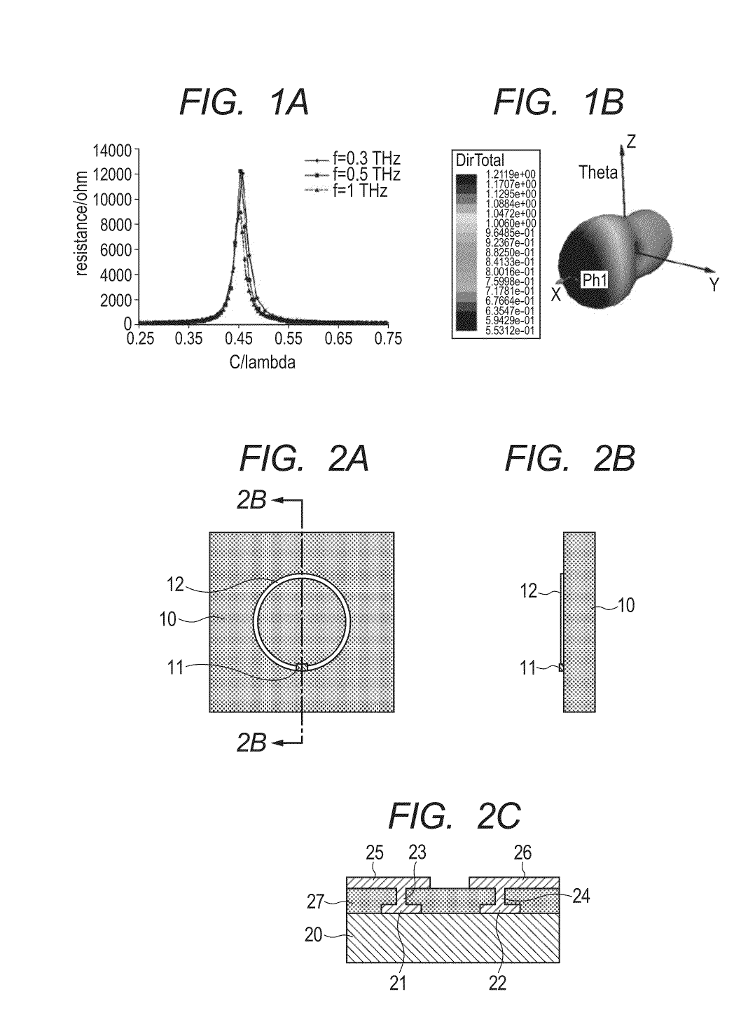

Described below are the results of calculating the impedances of three planar coils (arranged in an X-Y plane of FIG. 1B), which are surrounded by vacuum, with the use of commercially available finite element method software “HFSS” (a product of Ansoft Corporation). The coils each have a conducting wire width of 4 μm. The three coils are varied from one another in radius so that one resonates at the half wavelength of a frequency 0.3 THz while the other two resonate at the half wavelength of frequencies 0.5 THz and 1 THz, respectively. The axis of abscissa in FIG. 1A indicates a value that is obtained by dividing a circumferential coil length C by a wavelength A of an electromagnetic wave in vacuum, and the coil length is selected so that the node described above falls on the midpoint. As is understood from the description given above, the resistance of the conducting wire is maximum when C/λ is around 0.5. A frequency at which the resistance of the conducting wire is maximum corresponds to the first anti-resonant frequency of the coil. The actual first anti-resonant frequency is a frequency at which C/λ is 0.45. This difference is due to the impedance of the feeding portion and effects of radiation from the conducting wire, that is, the shape of the conducting wire. The present invention takes this into consideration as well.

A radiation pattern illustrated in FIG. 1B is of the coil that is driven on 0.3 THz. The coil is arranged in the X-Y plane, and an axis thereof (a straight line that runs through the center of gravity of the coil and that is perpendicular to a plane defined by the coil) runs along the Z-axis. The feeding portion is arranged on the X-axis. The coil in FIG. 1B radiates energy in a direction in which the feeding portion is located.

The following is a description on embodiments of the present invention. However, the present invention is not limited to the embodiments and various modifications and changes can be made without departing from the spirit of the present invention.

### First Embodiment

A first embodiment of the present invention deals with a terahertz-range detection device. Several principles have been proposed as the operation principle of a detecting device configured to detect electromagnetic waves in the terahertz range. In one of the proposed principles, an antenna collects electromagnetic waves transmitted through a medium that surrounds the detection device (for example, the air), and an electronic element including a rectifying element converts a signal in a high frequency range into a signal in a low frequency range. The low frequency signal can easily be handled by a regular electronic element. Terahertz-range rectifying elements that have been proposed include Schottky barrier diodes (SBDs) and plasmon-type field effect transistors (FETs).

SBDs and plasmon-type FETs have very high impedances at a high frequency. SBDs need to be small in the size of a Schottky junction in order to make the cutoff frequency high, and consequently have a high resistance. To maximize power transmitted from the antenna to the rectifying element, the conjugate matching condition between the rectifying element and the antenna needs to be fulfilled as much as possible. An antenna high in resistance is therefore formed in this embodiment.

In a first example of this embodiment illustrated in FIGS. 2A and 2B, an electronic element or circuit 11, which includes a rectifying element, is integrated on a semiconductor substrate 10. FIG. 2B is a sectional view taken along the line 2B-2B in FIG. 2A. The electronic element is integrated onto the semiconductor substrate. The electronic element is an electronic circuit configured to convert a signal having a terahertz-range frequency into a signal that is in a frequency range lower than the terahertz range. The semiconductor substrate in this example is made of silicon or a III-V semiconductor material because SBDs can be manufactured from various semiconductors. A coil-shaped antenna 12 is electrically connected to the electronic element 11. The antenna 12, which has a circular coil in this example, can have various other coil shapes such as a quadratic coil shape and a triangular coil shape. The antenna 12 is set to a length (total length) that makes the antenna 12 resonate at the first anti-resonant frequency at the operating frequency. This length is, for example, approximately half the wavelength of a current in the antenna. The coil-shaped antenna in this example is in contact with the semiconductor substrate on most of its semiconductor substrate-side surface.

In the case of a monolithic semiconductor substrate, the wavelength of a steady-state current in the coil-shaped antenna can be regarded as being based on the wavelength of an electromagnetic wave transmitted through the semiconductor. This wavelength is dependent on the frequency of the electromagnetic wave and the permittivity of the material. The rectifying element is formed from layers of a plurality of materials in some cases. For instance, a Schottky barrier diode may include a dielectric portion interposed between the Schottky junction and the antenna. The dielectric portion is a layer of, for example, silicon dioxide or silicon nitride. The presence of this or similar layer makes the medium seem as a mixture of the semiconductor substrate and the layers stacked on the substrate, instead of the semiconductor substrate alone or the stacked layers alone, to the current in the antenna. The wavelength of the current in the antenna is accordingly defined by the effective permittivity of the whole structure that surrounds the coil-shaped antenna.

This effective permittivity can be measured by preparing transmission lines of varying lengths that are layered on the surface of the semiconductor substrate. The transmission lines are terminated by being open-ended or short-circuited, or with a resistor. The impedances of the transmission lines are measured with a network analyzer. The impedance of a line is a function of the length of the line and the frequency, and the wavelength in the transmission lines layered on the semiconductor substrate is calculated from the maximum impedance and minimum impedance of the transmission lines. Some network analyzers have an operating frequency range up through 1.1 THz, and the characteristics of those transmission lines at a frequency as high as 1.1 THz can be obtained with this type of network analyzer. The effective permittivity measured in this manner may depend on the shape of the transmission lines to some degree. For that reason, it is preferred in some cases to directly measure the first anti-resonant frequency of the coil-shaped antenna with the use of a network analyzer that operates in a relevant frequency range.

The design may be simplified by removing the dielectric layer from the layered portion of the SBD and arranging the antenna directly on silicon. Specifically, the dielectric layer of the SBD that is a silicon dioxide layer or a silicon nitride layer can be removed with the use of a photoresist mask and buffered hydrofluoric acid (BHF). The photoresist mask is shaped by patterning, and the dielectric is removed from a region where the antenna is formed except the SBD portion. However, the following should be noted. The removed part of the dielectric layer does not need to be shaped to exactly conform to a metal pattern of the antenna. This is because the characteristics of the antenna depend on an electromagnetic field that is emitted by the antenna and that is located close to the metal pattern of the antenna. A part of the dielectric layer that stretches beyond the metal pattern of the antenna may therefore be removed.

An example of the SBD is illustrated in the sectional view of FIG. 2C. An N-type silicon layer 20 layered on a silicon wafer is connected to a metal element 21, which forms a Schottky junction, and another metal element 22, which forms a resistive junction. The metal elements 21 and 22 are electrically connected to two portions 25 and 26 of the antenna through two via holes 23 and 24, respectively. The two portions 25 and 26 of the antenna may be connected to each other. The metal elements and 22 and the via holes 23 and 24 are formed in a dielectric layer 27, which is, for example, a silicon dioxide layer, in order to facilitate the manufacture of the SBD. The dielectric layer 27 is layered on the N-type silicon layer 20 to support the antenna portions 25 and 26.

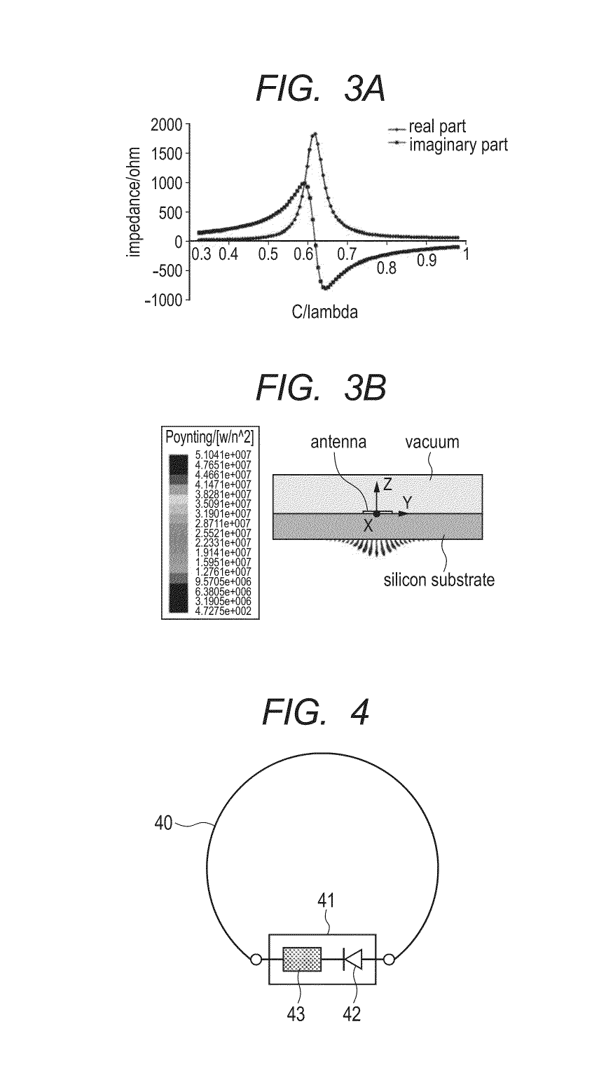

FIG. 3A is a graph for showing the impedance of the coil-shaped antenna described above. The impedance was calculated with the use of the software HFSS. The coil-shaped antenna has a conducting wire width of 3 μm and a radius of 9 μm. Most of the coil-shaped antenna is in direct contact with the silicon substrate, which takes up the lower half of the space. The axis of abscissa in FIG. 3A indicates a value that is obtained by dividing the coil length by the wavelength of an electromagnetic wave transmitted through the silicon substrate. The permittivity of the silicon substrate is set to 11.9. It can be seen in the graph of FIG. 3A that the coil-shaped antenna exhibits as high a resistance as 1,500Ω or more. The first anti-resonant frequency (the peak frequency of the real part) is around a point where the ratio of the coil length to the wavelength is 0.61, which corresponds to 915 GHz in frequency. This calculation result indicates that there is a range of resonance. The resistance at +15% of a frequency that corresponds to the maximum resistance is 180Ω and the resistance at −15% of the frequency is 110Ω. This is an impedance higher than those of antennas in the related art, and an antenna high in radiation impedance is thus realized. The detection device can thus be driven at a frequency within ±15% of the first anti-resonant frequency.

It is an object of this embodiment to maximize the energy transmission between the antenna and the electronic circuit. Ideally, the energy transmission is maximized around a point where a conjugate match is achieved. In actuality, there is a conjugate state that is best for the maximum energy transmission. However, the impedance of the antenna at the first anti-resonant frequency is not always the best conjugate match with the impedance of the electronic circuit. For example, in the case where the impedance of the electronic circuit is lower than the impedance of the antenna at the first anti-resonant frequency, the best conjugate state occurs around, but not at, the first anti-resonant frequency. This embodiment therefore uses a first anti-resonance peak range. The calculation result described above indicates that there is a range of resonance. The resistance at +15% of the frequency that corresponds to the maximum resistance is 180Ω and the resistance at −15% of the frequency is 110Ω as described above. The width of the peak range varies in relation to the loss in the antenna. The loss in the antenna varies in relation to the material of the antenna, but does not affect the target frequency range. It is therefore logical to determine the width of the first anti-resonance peak range based on the result of a simulation in the target frequency range.

FIG. 3B is a diagram for illustrating the Poynting vector of an electromagnetic wave that is emitted by the antenna at the first anti-resonant frequency. It is understood from FIG. 3B that most of the energy radiated by the antenna is radiated into the silicon substrate. This is because the permittivity of silicon is much higher than the permittivity of the vacuum space above the silicon substrate. When the antenna is connected to the rectifying element, the rectifying element generates an electrical signal in a low frequency range that corresponds to the fluctuations of a signal received by the antenna. In the case of a THz camera, the signal oscillates at a frequency in the terahertz range, and the fluctuations have a frequency below the terahertz range. The fluctuations correspond to changes to an image recorded by the camera. The signal of low frequency is a video signal and the low frequency is called a video frequency.

In the case where the rectifying element is connected directly to the coil-shaped antenna, a rectification signal generated by the rectifying element is short-circuited by the coil-shaped antenna because the coil-shaped antenna is a short circuit to the rectification signal, which has a low frequency. This needs to be taken into consideration when the rectifying element of the electronic element is connected to the coil-shaped antenna. An example of this circuit is illustrated in FIG. 4. A coil-shaped antenna 40 is electrically connected to an electronic element 41 in which a diode 42 and a resistor 43 are connected in series. At a low frequency, the diode is regarded as a low frequency generator that is connected in series to the resistor, and the antenna corresponds to a short circuit. A signal generated from the diode can be measured by monitoring one of the voltage and current of the resistor. At a THz frequency, the coil-shaped antenna functions as a THz frequency generator. The impedance viewed from the antenna is the sum of the impedances of the diode and the resistor. The impedance of the antenna needs to be a conjugate match with the sum of the impedances of the diode and the resistor in order to maximize the power transmission from the antenna to the diode. The resistance needs to be minimized in order to reduce power dissipated as heat at the resistor and thereby prevent a drop in sensitivity. On the other hand, the resistance of a diode that operates in the terahertz range is expected to be on the order of several thousand Ω, and the resistor of several ten Ω is responsible for merely a few percent of the overall loss of the system. A capacitor may be used in place of the resistor.

A second example of the first embodiment relates to an example of collecting energy that is radiated into a semiconductor substrate. Also in the second example, an electronic element that includes a rectifying element is integrated on a semiconductor substrate, and the electronic element is electrically connected to a coil-shaped antenna. The coil-shaped antenna formed on the semiconductor substrate is excited at a frequency around the first anti-resonant frequency. In this example, a silicon lens is formed on the back surface of the semiconductor substrate in order to collect the radiated energy.

In the case where the present invention is applied to a detection device, an electromagnetic wave detected is collected by the silicon lens, and transmitted to the antenna to cause a current in the antenna. The current emits its own electromagnetic wave, which cancels out the detected electromagnetic wave. Assuming that there is no loss in the antenna, power canceled out by the electromagnetic wave that is emitted from the antenna is equivalent to power that is transmitted to the electronic element connected to the antenna. The detection-use antenna and the radiation-use antenna therefore have an identical structure.

A third example of the first embodiment relates to a configuration in which an electromagnetic wave emitted by an antenna is increased and controlled. Also in the third example, an electronic element that includes a rectifying element is integrated on a semiconductor substrate, and the electronic element is electrically connected to a coil-shaped antenna. The antenna is formed on the semiconductor substrate. In this example, a metal layer functioning as a reflector is formed on the back surface of the semiconductor substrate in order to change the directivity of an electromagnetic wave emitted by the antenna. It is preferred to increase the power of the electromagnetic wave by making the phase of the reflected wave the same as the phase of the emitted wave. To that end, the thickness of the semiconductor substrate is set to ¼ of the wavelength of the electromagnetic wave transmitted through the semiconductor substrate. The thickness of the semiconductor substrate may also be an odd multiple of the ¼ wavelength without changing the function and effect.

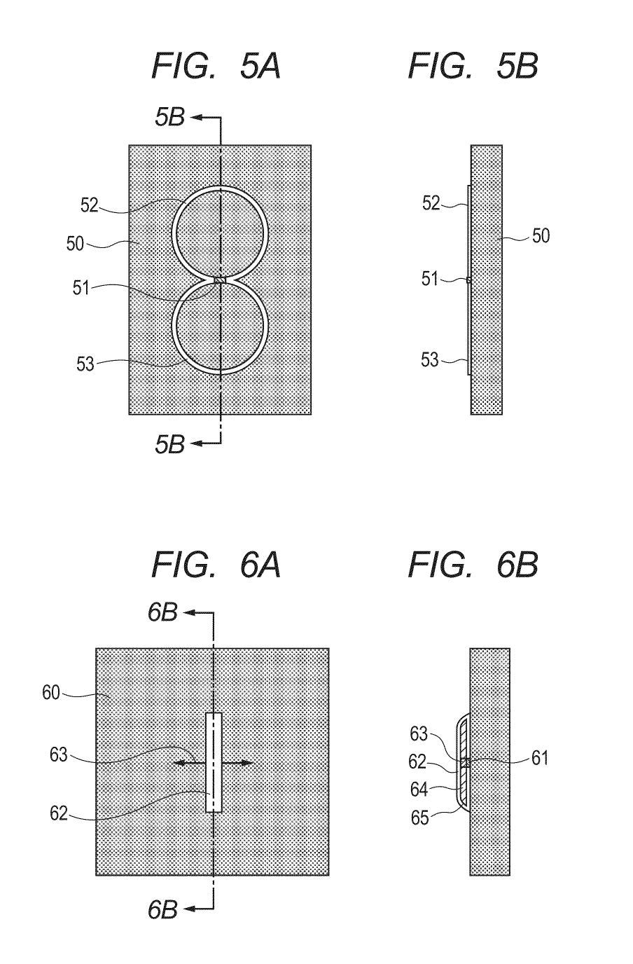

The size of the antenna is too small in some cases, particularly when compared to the size of a pixel, which is integrated with another element such as an amplifier or a readout circuit. The power emitted or collected by the antenna depends on the effective area of the antenna. For physical reasons, the effective area of the antenna cannot be smaller than the physical area of the antenna and does not depart too much from the physical area. It therefore pays to increase the physical area of the antenna, without changing other characteristics of the antenna, for the purpose of increasing power that is emitted or collected by the antenna. In a fourth example of the first embodiment which is illustrated in FIGS. 5A and 5B, an electronic element 51, which includes a rectifying element, is formed on a semiconductor substrate 50 and an antenna is formed on the semiconductor substrate 50 as well. FIG. 5B is a sectional view taken along the line 5B-5B in FIG. 5A. This antenna has two coil portions, 52 and 53, which are connected to each other and to the one electronic element. The two coil portions are mirror images with respect to a line that runs through the electronic element and is in contact with the coil portions. The two coil portions are excited at a frequency around the first anti-resonant frequency in this example as well, thereby generating a high resistance.

In a certain frequency range, the physical area of a single coil portion can be handled as an equivalent to the combined physical area of the two coil portions of the fourth example. Then, the physical area of the two coil portions is twice the physical area of a single coil portion. It is estimated from the relation between the physical area and effective area of the antenna described above that the effective area of the coil-shaped antenna that has two coil portions is approximately twice the effective area of an antenna that has a single coil portion.

Small-area coils are also attracting attention. With a small-area antenna, the pixel size can be made small, which means that the resolution of the imaging system can be set high. Although the resolution is limited by diffraction in some systems such as telescopes and cameras, the resolution of a contact imaging system where no lens intervenes is not regulated by diffraction and is determined directly by the pixel size.

In a fifth example of the first embodiment, high resolution is accomplished with a small-sized pixel in contact imaging. The fifth example is illustrated in FIGS. 6A and 6B. FIG. 6B is a sectional view taken along the line 6B-6B in FIG. 6A. An electronic element 61, which includes a rectifying element, is integrated on a semiconductor substrate 60. A coil-shaped antenna 62 is connected electrically to the electronic element 61. The coil length is set so that, at the operating frequency, the coil-shaped antenna resonates at the first anti-resonant frequency. As described above, the coil-shaped antenna emits an electromagnetic wave in vacuum in a dominant direction, which is within a plane defined by the coil-shaped antenna and runs through the electronic circuit. The dominant direction of the radiation pattern of the antenna on the semiconductor substrate runs toward the semiconductor substrate because the permittivity of a semiconductor is much higher than the permittivity of the air or vacuum. For those reasons, the coil-shaped antenna stands upright on the semiconductor substrate 60 as illustrated in FIGS. 6A and 6B.

To describe in more detail, a coil axis 63, which is an axis that runs through the center of gravity of the coil, is perpendicular to the plane of the coil and is parallel to the surface of the semiconductor substrate. The coil-shaped antenna consequently emits an electromagnetic wave in the dominant direction, which runs toward the semiconductor substrate side. The area on the semiconductor substrate taken up by the coil-shaped antenna that stands upright on the substrate is as small as the product of the width of a conducting wire that forms the coil and an approximate half of the total coil length.

This antenna can be manufactured by the following method. First, a silicon substrate having an electronic circuit that includes a rectifying element integrated thereon is prepared. A lower layer of the coil-shaped antenna is layered next. This method uses metal vapor deposition, photolithography, and metal etching to execute patterning and electrically connect the lower layer to the electronic circuit. The surface of the silicon substrate is then coated with benzocyclobutene (BCB) by spin coating. The BCB coat is subsequently patterned by photolithography and reactive ion etching (RIE). RIE uses CF₄ and oxygen gas to expose the ends of a lower part of the coil. A supporting portion 64, which supports an upper part of the coil, is formed in this manner.

The upper part of the coil is formed next by metal vapor deposition, photolithography, and metal etching. The upper part of the coil is connected to the lower part of the coil at the ends of the lower part. Forming a BCB portion, which has a tapered portion 65, near a region where the upper coil part and the lower coil part are connected simplifies the metal vapor deposition and connection of the upper coil part.

According to each example of the first embodiment, an antenna having a high radiation impedance is realized. The antenna is thus capable of fulfilling the conjugate matching condition in a favorable manner in an electromagnetic wave detecting/generating device when used in combination with a rectifying element or the like that operates in a terahertz range and is high in impedance.

In addition, the radiation pattern of the antenna has directivity in a dominant (main) direction, irrespective of, for example, whether the antenna is arranged directly on a silicon substrate or is arranged on a reflector that is integrated in the silicon substrate. The antenna can thus radiate power mainly in the dominant direction out of all directions in the space.

### Second Embodiment

In the terahertz-range detection device of the first embodiment, an antenna having a high resistance matches a rectifying element or the like that is high in resistance, and the radiation pattern of the antenna is controlled with a silicon lens or a reflector. However, there are cases where the radiation pattern needs to be controlled further. For example, using a silicon lens is undesirable in an imaging system that is constructed by integrating a plurality of detection devices on a single substrate because it means that the focuses of a plurality of lenses need to be adjusted with accuracy. Forming a metal reflector on the back surface of a substrate to adjust the thickness of the substrate also has a problem in that it makes it difficult to integrate detection devices sensitive to a plurality of frequencies on a single substrate because the thickness of the substrate needs to be adjusted to suit the plurality of frequencies of the detection devices. A second embodiment of the present invention solves those difficulties.

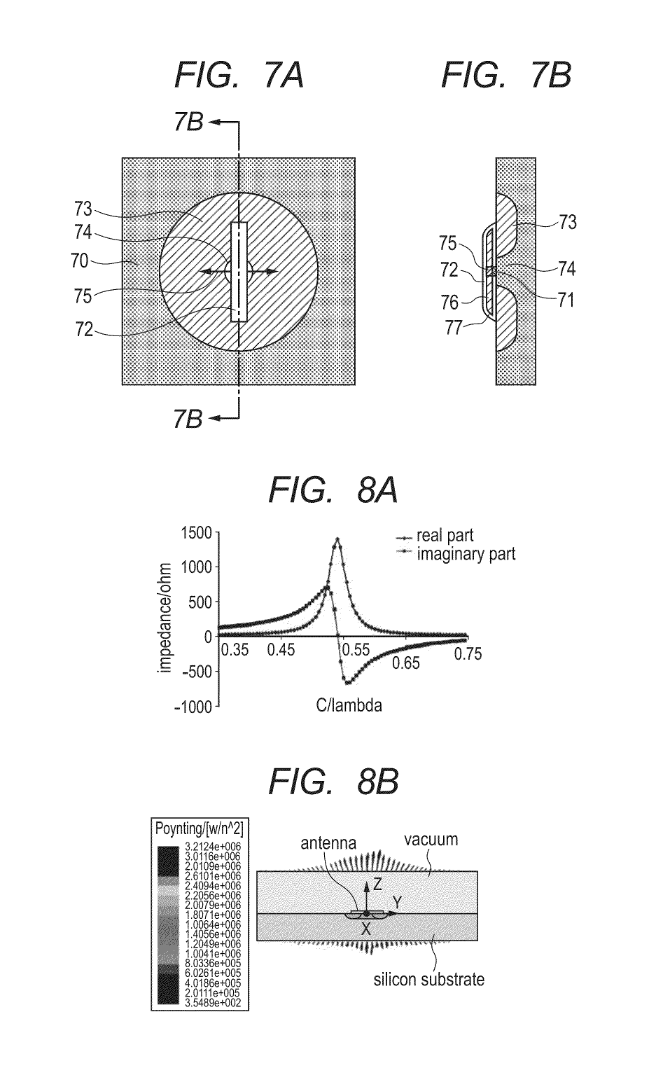

FIGS. 7A and 7B are diagrams of a first example of the second embodiment. FIG. 7B is a sectional view taken along the line 7B-7B in FIG. 7A. An electronic element or circuit 71, which includes a rectifying element, is integrated in a semiconductor substrate 70. The electronic element is electrically connected to a coil-shaped antenna 72. The emission of an electromagnetic wave from the antenna into the semiconductor substrate is prevented by opposing the antenna to a reflector 73, which is integrated in the semiconductor substrate. A pillar portion 74 stretching from where the reflector 73 is located supports the electronic element 71 so that the electronic element 71 is arranged on the substrate. The coil-shaped antenna is excited at a frequency around the first anti-resonant frequency, thereby giving the antenna a high resistance that matches the resistance of the rectifying element or the like. In the first embodiment, the coil-shaped antenna driven at the first anti-resonant frequency emits an electromagnetic wave in the dominant direction that runs through the electronic element and that is perpendicular to the coil axis. In the second embodiment, the coil axis is parallel to the surface of the substrate in order to make use of the emission in the dominant direction. A coil axis 75 in FIGS. 7A and 7B also runs in a direction that is perpendicular to a plane defined by the coil.

FIGS. 8A and 8B are diagrams for illustrating the simulation result of a system according to the first example of the second embodiment (the simulation is calculated with the finite element method software described above). In this example, a sheet-shaped coil having a width of 5 μm and a length of 92 μm is formed above a recess portion that has a depth of 10 μm and that is filled with BCB (permittivity: 2.6). The distance between an upper part and lower part of the coil is 2 μm. FIG. 8A is a graph for showing the impedance of this coil-shaped antenna. As can be seen in FIG. 8A, the impedance of the antenna at the first anti-resonant frequency peaks at as high a resistance as 1,000Ω, or higher. The axis of abscissa indicates the ratio of the length of the antenna to the wavelength in this example as well. The speed of the electromagnetic wave used here is that of the electromagnetic wave transmitted through BCB. The coil resistance is maximum at a point where the antenna length-wavelength ratio is 0.55. This is a value at a point where the antenna length is approximately half the wavelength of the electromagnetic wave as described in the first embodiment.

The result of the calculation indicates that there is a range of resonance. The resistance at +15% of a frequency that corresponds to the maximum resistance is 54Ω and the resistance at −15% of the frequency is 64Ω. This is an impedance higher than those of antennas in the related art, and an antenna high in radiation impedance is thus realized. FIG. 8B is a diagram for illustrating the Poynting vector of an electromagnetic wave that is emitted by this antenna. Most of the electromagnetic wave is emitted to a vacuum space above the semiconductor substrate, instead of into the substrate as in FIGS. 3A and 3B of the first embodiment.

The following is a description on an example of the manufacturing process of the device described above. First, a silicon wafer having a Schottky barrier diode integrated thereon is prepared. A recess portion of a given shape which has the pillar portion 74 is formed in the silicon wafer by RIE that uses SF₆ and photolithography. Next, the walls of the recess portion are coated with metal layers by vapor deposition that uses an electron beam and by photolithography, and the recess portion is filled with BCB by spin coating and mechanical polishing. The BCB coat is etched by RIE that uses CF₄ and oxygen gas to adjust the thickness of the BCB coat with precision.

In order to form the lower part of the standing coil, a first metal layer is then layered by patterning that uses vapor deposition by an electron beam, photolithography, and metal dry etching. The substrate is next covered with a BCB layer that is patterned by photolithography and dry etching so as to cover the lower part of the standing coil. The supporting portion 76 (see FIGS. 7A and 7B), which supports the upper part of the coil, is formed in this manner. A second metal layer is layered next and patterned so as to cover the BCB layer, and is connected to the lower part of the standing coil. The second metal layer thus forms the upper part of the standing coil. In this example, a member arranged above the lower part of the coil-shaped antenna supports the upper part of the antenna. In the coil-shaped antenna formed on the semiconductor substrate, the lower part and upper part of the coil-shaped antenna are parallel to the plane of the semiconductor substrate over a length that is, for example, approximately 80% of the total length of the coil-shaped antenna. The length over which the lower antenna part and the upper antenna part are parallel to the plane of the semiconductor substrate is desirably 80% or more of the total length of the coil-shaped antenna.

It is preferred for the BCB layer, which is sandwiched between the two coil parts, to have the tapered portion 77 (see FIGS. 7A and 7B) in a region where the two coil parts are connected, in order to simplify the fabrication of the coil. This makes it easy to layer the upper metal part of the coil from the front side of the substrate by, for example, vapor deposition that uses an electron beam.

In the first example, while most of the power is radiated to the outside of the semiconductor substrate, some of the power is still radiated into the substrate as illustrated in FIG. 8B. This problem is solved by a second example of the second embodiment. As illustrated in FIGS. 1A and 1B, an electromagnetic wave emitted by the coil-shaped antenna that is excited at the first anti-resonant frequency is emitted mainly in a direction that is perpendicular to the coil axis and that runs through the electronic element. In the case where the antenna is arranged above the recess portion, which contains the electronic element integrated into the pillar portion, some of the energy radiated from the antenna passes through the pillar portion to be emitted into the substrate. The second example is configured so as to deal with this phenomenon.

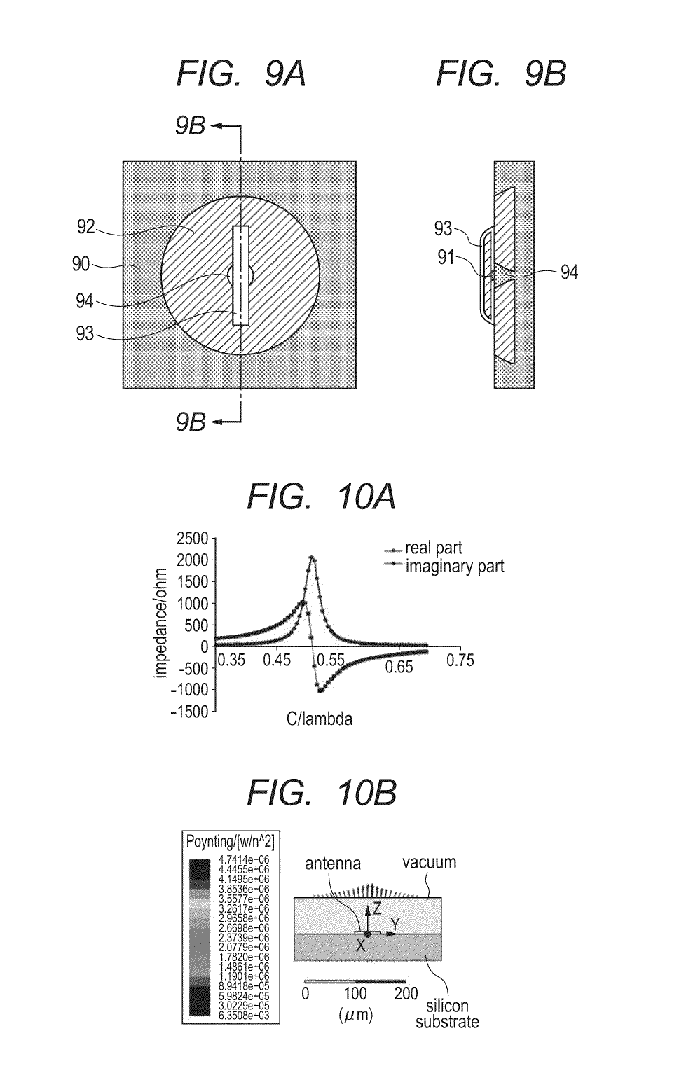

FIGS. 9A and 9B are diagrams for illustrating the second example of the second embodiment. FIG. 9B is a sectional view taken along the line 9B-9B in FIG. 9A. An electronic element 91, which includes a rectifying element, is integrated on a semiconductor substrate 90. A reflector 92 is integrated in the semiconductor substrate 90, and a coil-shaped antenna 93, which is electrically connected to the electronic element 91, is arranged on the reflector 92. The electronic element 91 is supported by a pillar portion 94. The pillar portion 94 has an inversely tapered shape in order to prevent an electromagnetic wave that is emitted by the antenna 93 from being transmitted to the inside of the substrate through the pillar portion 94. Specifically, the pillar portion 94 has an inversely tapered shape that increases in cross-sectional area from the bottom of a recess portion toward the electronic element side. A reflective layer is further formed on a surface of the inversely tapered shape. With the inversely tapered portion thus covered with a metal layer, an electromagnetic wave emitted toward the pillar portion 94 is reflected by the metal layer and returns to the side above the substrate 90.

FIGS. 10A and 10B are diagrams for illustrating the simulation result of a system according to the second example of the second embodiment (the simulation is calculated with the finite element method software described above). The mode of the second example used in the simulation is similar to that of the first example of the second embodiment except that the coil length is 85.4 μm and that the pillar portion has an inversely tapered shape. FIG. 10A is a graph for showing the impedance of the coil. It can be seen in FIG. 10A that the coil resistance is slightly higher relative to the impedance of the mode in which the pillar portion is tapered normally instead of inversely. The axis of abscissa indicates the ratio described above in this example as well. The speed of the electromagnetic wave used here is that of the electromagnetic wave transmitted through BCB. The coil resistance is maximum around a point where the antenna length-wavelength ratio is 0.5. This is a value around a point where the antenna length is approximately half the wavelength of the electromagnetic wave as described in the first embodiment.

The result of the calculation indicates that there is a range of resonance. The resistance at +15% of a frequency that corresponds to the maximum resistance is 78Ω and the resistance at −15% of the frequency is 63Ω. This is an impedance higher than those of antennas in the related art, and an antenna high in radiation impedance is thus realized. FIG. 10B is a diagram for illustrating the Poynting vector of an electromagnetic wave that is emitted by this antenna. Most of the electromagnetic wave is emitted to a vacuum space above the semiconductor substrate, instead of into the substrate as in the first embodiment. More of the energy is radiated toward the space above the substrate than when the pillar portion is tapered normally instead of inversely. In contrast, less of the energy is radiated into the substrate.

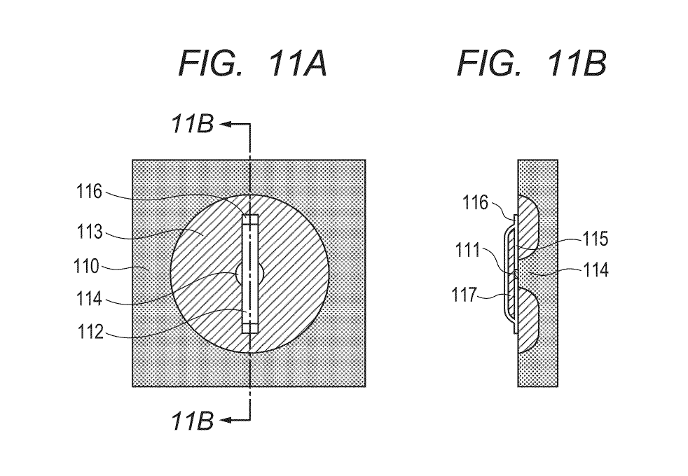

It is not easy to accomplish a favorable electrical connection at the connecting portion where the ends of the upper part of the coil-shaped antenna and the ends of the lower part of the antenna are connected to each other because the area of the connecting portion is small. For the same reason, very precise positioning is required to align the upper part and lower part of the antenna. A third example of the second embodiment solves this problem. The third example illustrated in FIGS. 11A and 11B is basically similar to the first example of the second embodiment. FIG. 11B is a sectional view taken along the line 11B-11B in FIG. 11A.

An electronic element 111, which includes a rectifying element, is integrated on a semiconductor substrate 110. The electronic element 111 is electrically connected to a coil-shaped antenna 112. A reflector 113 integrated in the semiconductor substrate 110 is formed so as to be opposed to the antenna 112 for the purpose of preventing an electromagnetic wave that is emitted by the antenna 112 from being transmitted to the inside of the substrate 110. A pillar portion 114 stretching from the reflector 113 is formed to connect the electronic element 111 to the substrate 110, and the electronic element 111 is supported at the pillar portion 114. Extended portions 116 are formed in a lower part 115 of a standing coil, and an upper part 117 of the standing coil is connected to the lower part 115 at the extended portions 116. The presence of the extended portions 116 yields an extra fabrication margin when the upper part of the standing coil is fabricated. The extended portions 116 do not change the resistance and radiation pattern of the antenna 112. The two extended portions 116 may be extended further to provide transmission lines connected to the coil. The coil may be electrically connected to another electronic element (for example, an amplifier or a switch) by the transmission lines.

Most of the energy radiated by the coil can be emitted toward the space above the substrate 110 or toward the reflector 113 in the case where the coil-shaped antenna 112 is stood upright on the reflector 113. The coil is therefore stood upright on the reflector 113, with most of the length of the coil directed parallel to the surface of the substrate 110, or parallel to the reflector 113.

The meaning of the direction defined by the coil is described. When the coil has a ribbon shape that has an upper part and a lower part stretching substantially parallel to each other across a narrow gap as in the second embodiment, the direction is defined by a certain part of the coil. In the case where the coil is made from a conducting wire, which does not have a principal surface, the direction is defined by a line tangent to a part of the coil that is included in a plane defined by the coil. In the case where the coil is formed by a semiconductor manufacturing technology, which is developed from surface micromachining, the coil typically has a ribbon shape. However, the coil also has a part that stretches in a direction that is perpendicular to a plane defined by the substrate surface, in order to electrically connect the lower part of the coil to the upper part of the coil.

According to each example of the second embodiment, an antenna having a high radiation impedance is realized as in the first embodiment. The antenna is thus capable of fulfilling the conjugate matching condition in a favorable manner in an electromagnetic wave detecting/generating device when used in combination with a rectifying element or the like that operates in a terahertz range and that is high in impedance.

In addition, the radiation pattern of the antenna has directivity in a dominant (main) direction, irrespective of, for example, whether the antenna is arranged directly on a silicon substrate or is arranged on a reflector that is integrated in the silicon substrate. The antenna can thus radiate power mainly in the dominant direction out of all directions in the space.

The described examples of the detection device can be applied or adapted to an electromagnetic wave generating device owing to the equivalence in configuration between an electromagnetic wave generating device that uses an antenna and an electromagnetic wave detecting device that uses an antenna. The electronic element in that case is an oscillator such as a resonant tunneling diode (RTD).

### Third Embodiment

A detector/generator is described in this embodiment. The detector/generator of this embodiment is an array-type image sensor that arranges a plurality of electromagnetic wave detecting/generating devices two-dimensionally on a plane, and is capable of detecting/generating an electromagnetic wave in a wide range. The plurality of electromagnetic wave detecting/generating devices can be the electromagnetic wave detecting/generating devices of the embodiments described above.

In order for the present invention to be useful as an image sensor, several antennas such as those described in the previous embodiments can be arranged in an array.

Some of the antennas described in the previous embodiments are of particular interest because they incorporate a reflector which prevents the antenna to be sensitive to electromagnetic waves propagating into the substrate and therefore conveying information which is not intended for this particular antenna or sensor.

Another interest of these antennas lies in their small size compared to the operating wavelength. The limited optical resolution of usual lenses makes it useless to design pixels of an image sensor smaller than the operating wavelength (depending on the f-number of the lens, it can be several times the operating wavelength). In the present invention, the length of the antenna is approximately half of the operating wavelength. Moreover, when the antenna is made standing on the surface of the substrate, the longest length of its footprint is half its length, which is a quarter of the operating wavelength. Because the antenna presented in the present invention is much smaller than the operating wavelength, and because there is no advantage in terms of resolution to design pixels smaller than the operating wavelength, it is therefore possible to design an image sensor including several antennas corresponding to the present invention into a single pixel. This is of particular interest because a single pixel can include sensors of each sensitive to a different wavelength, without reducing the spatial resolution of the image sensor. Also, a single pixel can include sensors of each sensitive to a different polarization, without reducing the spatial resolution of the image sensor.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2014-244601, filed Dec. 3, 2014, and Japanese Patent Application No. 2015-212602, filed Oct. 29, 2015, which are hereby incorporated by reference herein in their entirety.

What is claimed is:

1. An electromagnetic wave detecting/generating device, comprising:
an electronic element; and
an antenna electrically connected to the electronic element, the antenna comprising at least one coil-shaped portion,
wherein the electromagnetic wave detecting/generating device is configured to be driven at a frequency within ±15% of a first anti-resonant frequency of the antenna.

2. The electromagnetic wave detecting/generating device according to claim 1, wherein the electronic element and the antenna are provided on a substrate.

3. The electromagnetic wave detecting/generating device according to claim 2,
wherein the substrate comprises a semiconductor substrate, and
wherein the electronic element is integrated onto the semiconductor substrate.

4. The electromagnetic wave detecting/generating device according to claim 3,
wherein the semiconductor substrate comprises a silicon substrate that is at least partially covered with a dielectric layer, and
wherein the antenna is arranged in the dielectric layer, and the dielectric layer is removed from at least a part of a bottom surface and side surfaces of the antenna.

5. The electromagnetic wave detecting/generating device according to claim 2, wherein the antenna is at least partially in contact with the substrate.

6. The electromagnetic wave detecting/generating device according to claim 1, wherein the antenna comprises two coil-shaped portions.

7. The electromagnetic wave detecting/generating device according to claim 6, wherein the two coil-shaped portions are mirror images with respect to a line that runs through the electronic element, and are connected to each other at the electronic element.

8. The electromagnetic wave detecting/generating device according to claim 1, wherein an axis defined by a straight line that runs through the center of gravity of the antenna and that is perpendicular to a plane defined by the antenna is perpendicular to a plane of the substrate on which the electronic element and the antenna are provided.

9. The electromagnetic wave detecting/generating device according to claim 1, wherein an axis defined by a straight line that runs through the center of gravity of the antenna and that is perpendicular to a plane defined by the antenna is parallel to a plane of the substrate on which the electronic element and the antenna are provided.

10. The electromagnetic wave detecting/generating device according to claim 9, wherein the antenna comprises a lower part, an upper part, and two connecting portions that respectively connect ends of the lower part to ends of the upper part.

11. The electromagnetic wave detecting/generating device according to claim 10, wherein the upper part of the antenna is supported by a member that is arranged above the lower part of the antenna.

12. The electromagnetic wave detecting/generating device according to claim 10, wherein a gap between the two connecting portions becomes narrower from the lower part to the upper part.

13. The electromagnetic wave detecting/generating device according to claim 10, wherein the lower part stretches beyond points where the lower part is connected to the connecting portions.

14. The electromagnetic wave detecting/generating device according to claim 10,
wherein the electronic element and the antenna are provided on a semiconductor substrate, and
wherein the lower part and the upper part are parallel to a plane of the semiconductor substrate over a length that is 80% or more of a total length of the antenna.

15. The electromagnetic wave detecting/generating device according to claim 1,
wherein the electronic element and the antenna are provided on a semiconductor substrate,
wherein the semiconductor substrate has a recess portion formed therein, and
wherein the electronic element is supported by a pillar portion, which stands upright in the recess portion.

16. The electromagnetic wave detecting/generating device according to claim 15, wherein the recess portion functions as a reflector.

17. The electromagnetic wave detecting/generating device according to claim 15, wherein the pillar portion has an inversely tapered shape that increases in cross-sectional area from a bottom of the recess portion toward the electronic element, and a reflective layer is formed on a surface of the inversely tapered shape.

18. The electromagnetic wave detecting/generating device according to claim 1, wherein the electronic element comprises a Schottky barrier diode.

19. The electromagnetic wave detecting/generating device according to claim 1, wherein the electronic element comprises an oscillator.

20. A detector/generator, comprising a plurality of electromagnetic wave detecting/generating devices arranged in a planar pattern,
wherein at least one of the plurality of electromagnetic wave detecting/generating devices comprises an electronic element and an antenna electrically connected to the electronic element, the antenna comprising at least one coil-shaped portion, and
wherein the at least one electromagnetic wave detecting/generating device is configured to be driven at a frequency within ±15% of a first anti-resonant frequency of the antenna.
